(19) United States
(12) Patent Application Publication
(10) Pub. No.: US 2009/0162627 A1
(43) Pub. Date: Jun. 25, 2009

(54) COLOR DEVELOPING STRUCTURE AND METHOD FOR MANUFACTURING COLOR DEVELOPING STRUCTURE

(75) Inventors: Toshimitsu HIRAI, Hokuto (JP); Yasushi TAKANO, Matsumoto (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Tokyo (JP)

(21) Appl. No.: 12/340,077

(22) Filed: Dec. 19, 2008

(30) Foreign Application Priority Data
Dec. 25, 2007 (JP) 2007-331531

(51) Int. Cl. B05D 5/06; B05D 1/36; B32B 7/02; B05D 3/02

(52) U.S. Cl. 428/213; 427/402; 427/372.2

(57) ABSTRACT

A method for manufacturing a color developing structure, includes: forming a first transparent thin film having a first refractive index with a first liquid material so that the first transparent thin film has a thickness determined based on predetermined color developing characteristics; forming a second transparent thin film having a second refractive index with a second liquid material so that the second transparent thin film has a thickness determined based on the predetermined color developing characteristics; and stacking the first transparent thin films and the second transparent thin films in layers by alternately repeating the forming of the first transparent thin film and the forming of the second transparent thin film multiple times so that the color developing structure having the predetermined color developing characteristics is obtained.

### CROSS-REFERENCE TO RELATED APPLICATION

This application is based on and claims priority from Japanese Patent Application No. 2007-331531, filed on Dec. 25, 2007, the contents of which are incorporated herein by reference.

### BACKGROUND

1. Technical Field

The present invention relates to a color developing structure and a method for manufacturing a color developing structure.

2. Related Art

As the design of decorative members (e.g., clock character sheet, bracelet, brooch, mobile phone case, etc.) and vehicle members (interior dashboard, etc.) has advanced, the feel of a material having a painted surface has been improved by using a mica flake or a processed mica as a brightness material, as well as known metallic painting using an aluminum flake brightness member.

The brightness member includes a pigment or a dye, and the brightness member influences color tone caused by the pigment or the dye. However, in the pigment or the dye, it is difficult to avoid fading in the present state.

A technique of a color developing structure focusing attention to a Morpho butterfly is described in Japanese Patent No. 3443656.

In this technique, a photocatalytic material thin film layer having a longitudinal rectangular shape and formed of TiO₂ or the like, and a supporting material thin film layer having a longitudinal rectangular shape thinner than the photocatalytic thin film layer and formed of SiO₂ are alternately laminated to form multilayer structures, and the multilayer structures are arranged to form a color developing member.

In the technique, after forming a multilayer thin film by sputtering or the like, a predetermined amount of a supporting material is removed by dry etching or wet etching to form an air space.

As described above, in the technique, since it is possible to widen a surface area coming into contact with a photocatalyst by the multilayer-film structure having the air space, a higher photocatalyst effect is expected.

Particularly, it is possible to realize clear color development such as metal luster, by a light interference effect caused by making the optical thicknesses of the photocatalyst layer and the air space ¼ of a color developing light wavelength, and a diffraction gird effect caused by the arranged structure.

However, in the above-described technique, there are the following problems.

In sputtering used to form the multilayer thin film layer or etching used to form the supporting material thin film layer, there are a large number of processes and large-scale equipment such as an exposure device is necessary. Accordingly, productivity is low.

### SUMMARY

An advantage of some aspects of the invention is to provide a color developing structure and a method for manufacturing a color developing structure, where it is possible to easily form a predetermined pattern.

A first aspect of the invention provides a method for manufacturing a color developing structure, including: forming a first transparent thin film having a first refractive index with a first liquid material so that the first transparent thin film has a thickness determined based on predetermined color developing characteristics; forming a second transparent thin film having a second refractive index with a second liquid material so that the second transparent thin film has a thickness determined based on the predetermined color developing characteristics; and stacking the first transparent thin films and the second transparent thin films in layers by alternately repeating the forming of the first transparent thin film and the forming of the second transparent thin film multiple times so that the color developing structure having the predetermined color developing characteristics is obtained.

In the method for manufacturing a color developing structure according to the invention, it is possible to form a color developing structure by a simple method of forming a film using a first liquid material and a second liquid material with a thickness determined based on the predetermined developing characteristics. Accordingly, large-scale equipment such as an exposure device is unnecessary, and thus it is possible to efficiently manufacture the color developing structure.

As characteristics of the color development, assuming that refractive indexes of a first liquid material (first transparent thin film) and a second liquid material (second transparent thin film) are n1 and n2, respectively, the thicknesses of the first transparent thin film and the second transparent thin film are t1 and t2, respectively, and refractive angles of the first transparent thin film and the second transparent thin film are θ1 and θ2; a reflective wavelength λ is represented by 2×(n1×t1×cos θ1+n2×t2×cos θ2) and a reflectance R (reflective intensity) is represented by (n1²−n2²)/(n1²+n2²).

When an optical thickness is n1×t1=n2×t2=λ/4, the color developing intensity is maximized.

Accordingly, in the invention, when the refractive indexes n1 and n2 and the refractive angles θ1 and θ2 are preset according to the used materials, it is possible to produce light having a desired wavelength with a high color developing intensity by appropriately setting the thicknesses t1 and t2 of the first transparent thin film and the second transparent thin film on the basis of the formula.

It is preferable that, in the method of the first aspect of the invention, at least one of the first transparent thin film and the second transparent thin film is formed by a liquid droplet ejection method.

In the first aspect of the invention, it is possible to efficiently apply the minimal amount of a liquid material onto desired regions only, thereby improving productivity.

It is preferable that, in the method of the first aspect of the invention, each of the forming of the first transparent thin film and the forming of the second transparent thin film include: applying a liquid material; and baking or drying the liquid material that has been applied.

In the first aspect of the invention, the first liquid material and the second liquid material are formed into films in the forming of the first transparent thin film and the forming of the second transparent thin film. Accordingly, it is possible to prevent the applied first liquid material and second liquid material from mixing to have a negative effect on the color developing characteristics.

It is preferable that, in the method of the first aspect of the invention, the first refractive index be less than the second refractive index, and the first transparent thin film be formed so that the thickness of the first transparent thin film is greater than the thickness of the second transparent thin film.

In the first aspect of the invention, it is possible to produce light having a desired wavelength with a high color developing intensity by appropriately selecting the film thicknesses t1 and t2 satisfying the relationship of the aforementioned formula n1×t1=n2×t2=λ/4.

It is preferable that, in the method of the first aspect of the invention, the color developing structure that is constituted by a plurality of the first transparent thin films and a plurality of the second transparent thin films include a lowermost layer, an uppermost layer, and a plurality of intermediate layers. In this method, the first transparent thin films and the second transparent thin films are formed so that the thicknesses of the transparent thin films that are positioned at the lowermost layer and the uppermost layer are greater than the thickness of the transparent thin film that is positioned at one of the intermediate layers.

This method of the first aspect of the invention is obtained based on the result of experiment and simulation. In the first aspect of the invention, it is possible to obtain satisfactory color developing characteristics.

In this case, it is particularly preferable that, in the method of the first aspect of the invention, the first transparent thin films and the second transparent thin films be formed so that the thicknesses of the transparent thin films that are positioned at the lowermost layer and the uppermost layer are twice the thickness of the transparent thin film that is positioned at one of the intermediate layers. In this case, it is possible to obtain satisfactory light emitting characteristics (reflective characteristics).

It is preferable that, in the method of the first aspect of the invention, the forming of the first transparent thin film and the second transparent thin film include at least one of the forming the first transparent thin film that has the thickness determined based on the particle diameter of a first formation material used for forming the first transparent thin film, and the forming the second transparent thin film that has the thickness determined based on the particle diameter of a second formation material used for forming the second transparent thin film.

In the first aspect of the invention, it is possible to precisely form at least one of the first transparent thin film and the second transparent thin film with a regular thickness having uniformity.

A second aspect of the invention provides a color developing structure including: a first transparent thin film that is formed with a first formation material, has a thickness determined based on predetermined color developing characteristics, and has a first refractive index; and a second transparent thin film that is formed with a second formation material, has a thickness determined based on the predetermined color developing characteristics, and has a second refractive index. In the color developing structure, the first transparent thin films and the second transparent thin films are alternately stacked in layers.

As characteristics of the color development, assuming that refractive indexes of a first formation material (first transparent thin film) and a second formation material (second transparent thin film) are n1 and n2, respectively, the thicknesses of the first transparent thin film and the second transparent thin film are t1 and t2, respectively, and refractive angles of the first transparent thin film and the second transparent thin film are θ1 and θ2; a reflective wavelength λ is represented by 2×(n1×t1×cos θ1+n2×t2×cos θ2) and a reflectance R (reflective intensity) is represented by (n1²−n2²)/(n1²+n2²).

When an optical thickness is n1×t1=n2×t2=λ/4, the color developing intensity is maximized.

Accordingly, in the invention, when the refractive indexes n1 and n2 and the refractive angles θ1 and θ2 are preset according to the used materials, it is possible to produce light having a desired wavelength with a high color developing intensity by appropriately setting the thicknesses t1 and t2 of the first transparent thin film and the second transparent thin film on the basis of the formula.

It is preferable that, in the color developing structure of the second aspect of the invention, the first refractive index be less than the second refractive index, and the first transparent thin film be formed so that the thickness of the first transparent thin film is greater than the thickness of the second transparent thin film.

In the second aspect of the invention, it is possible to produce light having a desired wavelength with a high color developing intensity by appropriately selecting the film thicknesses t1 and t2 satisfying the relationship of the aforementioned formula n1×t1=n2×t2=λ/4.

It is preferable that, in the color developing structure of the second aspect of the invention, the color developing structure that is constituted by a plurality of the first transparent thin films and a plurality of the second transparent thin films include a lowermost layer, an uppermost layer, and a plurality of intermediate layers. In this color developing structure, the first transparent thin films and the second transparent thin films are formed so that the thicknesses of transparent thin films that are positioned at the lowermost layer and the uppermost layer are greater than the thickness of a transparent thin film that is positioned at one of the intermediate layers.

This color developing structure of the second aspect of the invention is obtained based on the result of experiment and simulation. In the second aspect of the invention, it is possible to obtain satisfactory color developing characteristics.

In this case, it is particularly preferable that, in the color developing structure of the second aspect of the invention, the first transparent thin films and the second transparent thin films be formed so that the thicknesses of the transparent thin films that are positioned at the lowermost layer and the uppermost layer are twice the thickness of the transparent thin film that is positioned at one of the intermediate layers. In this case, it is possible to obtain satisfactory light emitting characteristics (reflective characteristics).

It is preferable that, in the color developing structure of the second aspect of the invention, the thickness of the first transparent thin film be defined based on the particle diameter of the first formation material.

In the second aspect of the invention, it is possible to precisely form the first transparent thin film with a regular thickness having uniformity.

It is preferable that, in the color developing structure of the second aspect of the invention, the thickness of the second transparent thin film be defined based on the particle diameter of the second formation material.

In the second aspect of the invention, it is possible to precisely form the second transparent thin film with a regular thickness having uniformity.

### BRIEF DESCRIPTION OF THE DRAWINGS

FIG. 1 is a perspective view showing a liquid drop ejection apparatus.

FIG. 2 is a cross-sectional view showing a liquid drop ejection head.

FIG. 3 is a cross-sectional view showing a color developing structure C having a multilayer structure formed on a substrate P.

FIGS. 4A to 4C are diagrams illustrating the relationship between a light emitting wavelength and a reflectance according to a first embodiment.

FIG. 5A is a diagram illustrating the refractive index and the thickness of each of eleven layers of a color developing structure C according to a second embodiment, and FIG. 5B is a diagram illustrating the relationship between wavelength and reflectance in the film structure shown in FIG. 5A.

FIG. 6A is a diagram illustrating the refractive index and the thickness of each of eleven layers of a color developing structure C according to the second embodiment, and FIG. 6B is a diagram illustrating the relationship between wavelength and reflectance in the film structure shown in FIG. 6A.

FIG. 7A is a diagram illustrating the refractive index and the thickness of each of eleven layers of a color developing structure C according to the second embodiment, and FIG. 7B is a diagram illustrating the relationship between wavelength and reflectance in the film structure shown in FIG. 7A.

FIG. 8A is a diagram illustrating the refractive index and the thickness of each of eleven layers of a color developing structure C according to the second embodiment, and FIG. 8B is a diagram illustrating the relationship between wavelength and reflectance in the film structure shown in FIG. 8A.

FIG. 9A is a diagram illustrating the refractive index and the thickness of each of eleven layers of a color developing structure C according to the second embodiment, and FIG. 9B is a diagram illustrating the relationship between wavelength and reflectance in the film structure shown in FIG. 9A.

FIG. 10A is a diagram illustrating the refractive index and the thickness of each of eleven layers of a color developing structure C according to the second embodiment, and FIG. 10B is a diagram illustrating the relationship between wavelength and reflectance in the film structure shown in FIG. 10A.

FIG. 11A is a diagram illustrating the refractive index and the thickness of each of eleven layers of a color developing structure C according to the second embodiment, and FIG. 11B is a diagram illustrating the relationship between wavelength and reflectance in the film structure shown in FIG. 11A.

FIG. 12A is a diagram illustrating the refractive index and the thickness of each of eleven layers of a color developing structure C according to the second embodiment, and FIG. 12B is a diagram illustrating the relationship between wavelength and reflectance in the film structure shown in FIG. 12A.

FIG. 13A is a diagram illustrating the refractive index and the thickness of each of eleven layers of a color developing structure C according to a third embodiment, and FIG. 13B is a diagram illustrating the relationship between wavelength and reflectance in the film structure shown in FIG. 13A.

### DESCRIPTION OF EXEMPLARY EMBODIMENTS

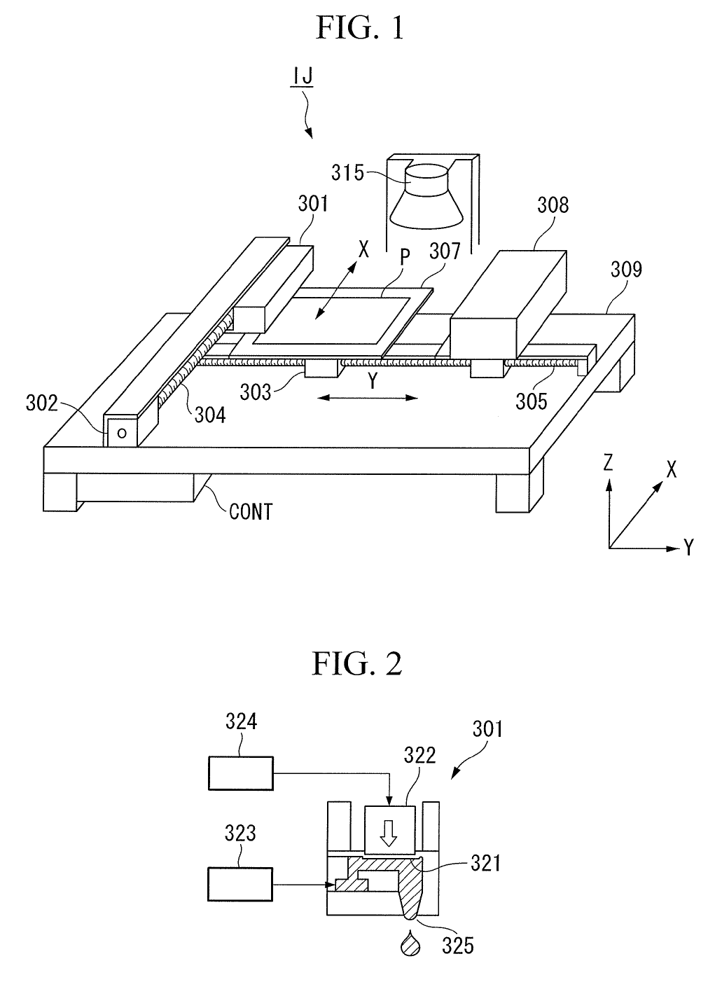

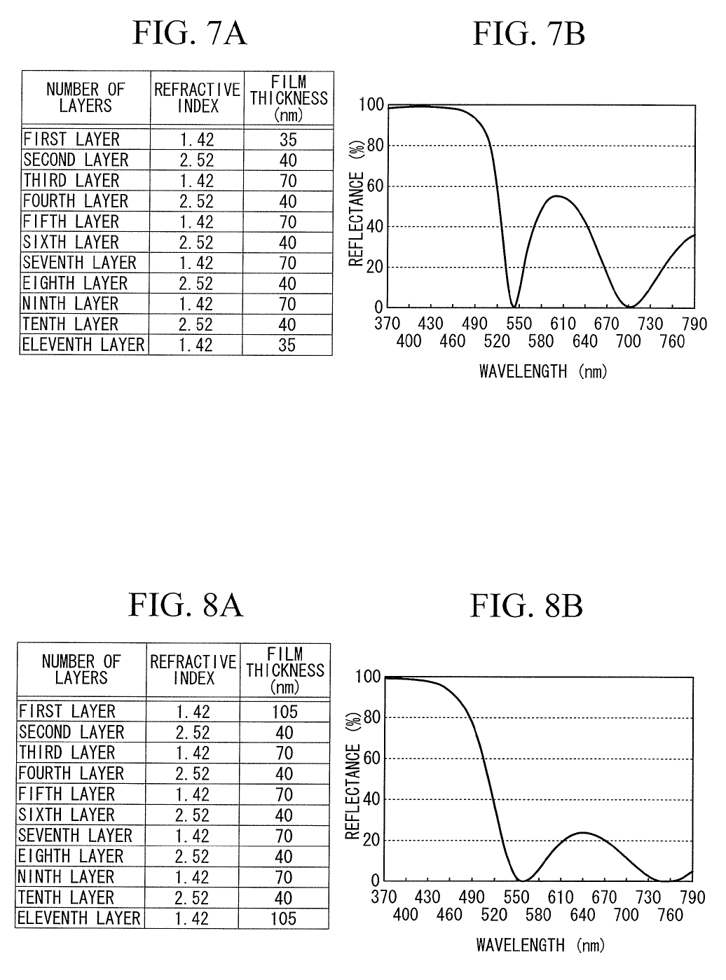

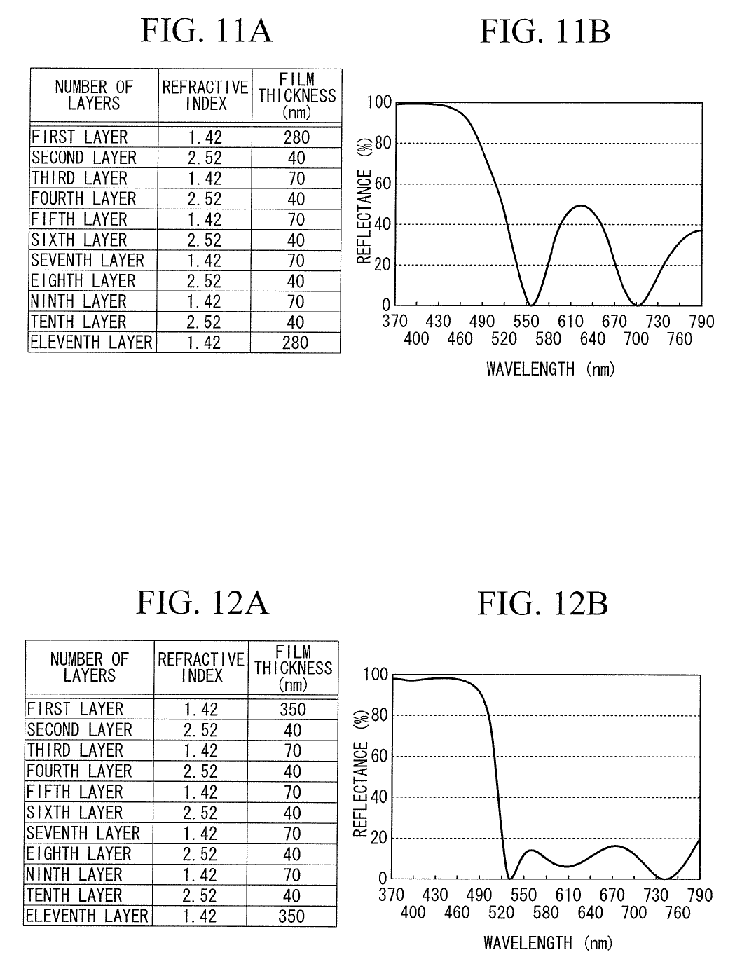

Hereinafter, embodiments of a color developing structure and a method for manufacturing a color developing structure will be described with reference to FIGS. 1 to 13B.

Liquid Drop Ejection Apparatus

Firstly, a liquid drop ejection apparatus for use in the manufacture of a method for manufacturing a color developing structure will be described.

FIG. 1 shows a liquid drop ejection apparatus.

A liquid drop ejection apparatus IJ (ink jet apparatus) ejects (drops) liquid drops from a liquid drop ejection head to a substrate P.

The liquid drop ejection apparatus IJ includes a liquid drop ejection head 301, an X direction drive axis 304, a Y direction guide axis 305, a controller CONT, a stage 307, a cleaning mechanism 308, a base 309, and a heater 315.

The stage 307 supports the substrate P to be provided with an ink (liquid material, liquid substance) by the liquid drop ejection apparatus IJ. The stage 307 includes a fixation mechanism (not shown) that fixes the substrate P in a reference position.

The liquid drop ejection head 301 is a multi-nozzle type liquid drop ejection head provided with a plurality of ejection nozzles. The longitudinal direction and X axis direction of the liquid drop ejection head 301 coincide.

The plurality of ejection nozzles are formed in the bottom surface of the liquid drop ejection head 301 in rows, in the X axis direction, spaced apart at a fixed distance.

An ink including fine conductive particles is ejected from the ejection nozzles of the liquid drop ejection head 301 to the substrate P supported on the stage 307.

An X direction drive motor 302 is connected to the X direction drive axis 304.

The X direction drive motor 302 is, for example, a stepping motor. When supplied with a drive signal for the X direction by the controller CONT, the X direction drive motor 302 causes the X direction drive axis 304 to rotate.

When the X direction drive axis 304 is rotated, the liquid drop ejection head 301 moves in the X axis direction.

The Y direction guide axis 305 is fixed so as not to move with respect to the base 309.

The stage 307 is provided with a Y direction drive motor 303.

The Y direction drive motor 303 is, for example, a stepping motor. When supplied with a drive signal for the Y direction by the controller CONT, the stage 307 moves in the Y direction.

The controller CONT supplies a voltage for controlling liquid drop ejection to the liquid drop ejection head 301.

Furthermore, the controller CONT supplies a drive pulse signal for controlling the movement in the X direction of the liquid drop ejection head 301 to the X direction drive motor 302, and supplies a drive pulse signal for controlling the movement in the Y direction of the stage 307 to the Y direction drive motor 303.

The cleaning mechanism 308 cleans the liquid drop ejection head 301.

The cleaning mechanism 308 is provided with a drive motor for the Y direction (not shown).

The cleaning mechanism 308 moves along the Y direction guide axis 305 by means of the drive motor in a manner in that the drive motor is driven in the Y direction.

The movement of the cleaning mechanism 308 is also controlled by the controller CONT.

The heater 315 herein is used for heating the substrate P by lamp annealing. The heater 315 evaporates and dries the solvent included in the liquid material applied on the substrate P.

Turning on and off of the heater 315 is also controlled by the controller CONT.

The liquid drop ejection apparatus IJ ejects liquid drops to the substrate P while relatively scanning the liquid drop ejection head 301 and the stage 307 for supporting the substrate P.

Here, in the description below, the Y direction is referred to as a scanning direction, and the X direction that is perpendicular to the Y direction is referred to as a non-scanning direction.

Therefore, the ejection nozzles of the liquid drop ejection head 301 are provided in lines, spaced apart at a fixed distance, in the X direction, that is, the non-scanning direction.

In FIG. 1, the liquid drop ejection head 301 is disposed perpendicularly to the traveling direction of the substrate P. However, the liquid drop ejection head 301 may be arranged to be intersected with the traveling direction of the substrate P by adjusting the angle of the liquid drop ejection head 301.

As a result, adjustment of the angle of the liquid drop ejection head 301 allows adjustment of pitches between the nozzles.

Therefore, the liquid drop ejection apparatus IJ may be configured so that the distance between the substrate P and the nozzle face is adjustable to any value.

FIG. 2 is a cross-sectional view of the liquid drop ejection head 301.

In the liquid drop ejection head 301, a piezo element 322 is disposed adjacent to a liquid chamber 321 that stores a liquid material (ink for wiring, etc.).

The liquid material is supplied to the liquid chamber 321 via a liquid supply system 323 including a material tank that stores the liquid material.

The piezo element 322 is connected to a drive circuit 324. A voltage is applied to the piezo element 322 via the drive circuit 324 to deform the piezo element 322. This, in turn, deforms the liquid chamber 321 to eject the liquid material from a nozzle 325.

In this case, the amount of deformation of the piezo element 322 is controlled by changing the value of the applied voltage.

Furthermore, the speed of deformation of the piezo element 322 is controlled by changing the frequency of the applied voltage.

Liquid ejection by the piezo system has an advantage in that it is difficult to affect the composition of a material, since heat is not applied to the material.

An electro-mechanical transformation system described above is not limited to the method of ejecting a liquid drop. As ejection techniques for a method of ejecting a liquid drop, a charging control system, a pressurized vibration system, an electro-thermal transformation system, an electrostatic attraction system, or the like can be adopted.

The charging control system is one in which an electric charge electrode imparts electric charge to a material and a deflection electrode ejects the material in the desired ejecting direction from the nozzle to the substrate.

The pressurized vibration system is one in which, for example, about 30 kg/cm² of super high pressure is applied to a material and the material is ejected on the tip of a nozzle. In this system, when a control voltage is not applied, the material is ejected from the nozzle in the straight direction. When the control voltage is applied, electrostatic repulsion is induced in the material and the material is scattered so as to be prevented from being ejected from the nozzle.

The electro-thermal transformation system is one in which a material is abruptly vaporized by a heater provided in a space where the material is stored to generate bubbles, and the material in the space is ejected by the pressure of the bubbles.

The electrostatic attraction system is a system in which a very small pressure is applied to the inside of a space where a material is stored, to form a meniscus of the material in a nozzle and, in this condition, electrostatic attraction is applied to draw out the material.

Other than these, techniques such as a system that utilizes change in viscosity of fluid by an electric field and a system in which a material is ejected by a discharge spark are also applicable.

The method of ejecting a liquid drop has advantages in that little is wasted in the use of material and that a desired amount of the material is exactly disposed in a desired position.

An amount of a drop of a liquid material (fluid substance) ejected by the method of ejecting a liquid drop is, for example, 1 to 300 nano grams.

### First Embodiment

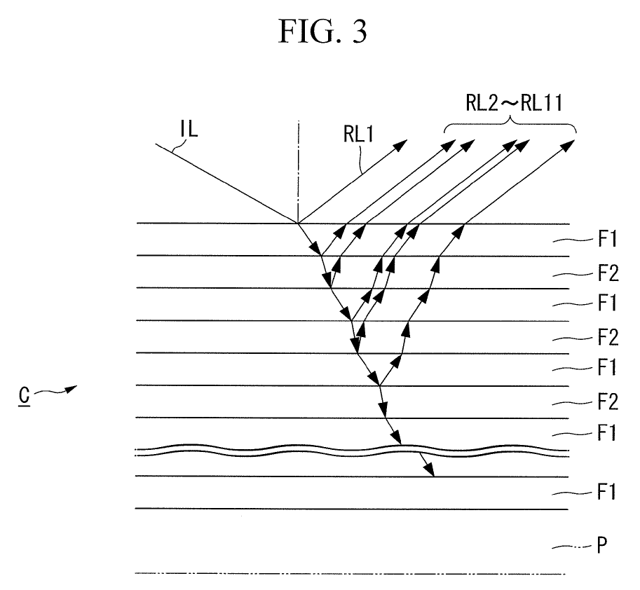

Next, using the above-described liquid drop ejection apparatus, a first embodiment of a method for manufacturing a color developing structure on a substrate P will be described with reference to FIG. 3.

Firstly, the configuration of a color developing structure will be described.

FIG. 3 is a cross-sectional view showing a color developing structure C having a multilayer structure formed on a substrate P.

The color developing structure C (first film body) shown in FIG. 3 is formed by alternately forming a plurality of first transparent thin films F1 and a plurality of second transparent thin films F2 having different refractive indexes.

In the embodiment, in order from the substrate P, the first transparent thin films F1 are formed in odd-numbered layers such as a first layer, a third layer, . . . , to an eleventh layer. Also, the second transparent thin films F2 are formed in even-numbered layers such as a second layer, . . . , to a tenth layer. Therefore, a color developing structure C is formed by the eleven-layer thin films.

As the substrate P (base body), a glass substrate, a Si substrate, a plastic substrate, a metal substrate, or the like may be appropriately selected.

As a material for forming the first transparent thin film F1 and the second transparent thin film F2, polysiloxane resin (refractive index 1.42), SiO₂ (quartz; 1.45), Al₂O₃ (alumina; refractive index 1.76), ZnO (zinc oxide; refractive index 1.95), titanium oxide (refractive index 2.52), Fe₂O₃ (iron oxide; refractive index 3.01), or the like may be appropriately selected.

To form the color developing structure C on the substrate P, firstly, liquid droplets of a first liquid material including a material (first formation material) for forming the first transparent thin film using the liquid drop ejection apparatus IJ are applied onto the substrate P with a predetermined thickness, and then it is dried, for example, at 180° C. for 1 minute and baked (cured) at 200° C. for 3 minutes. As a result, the first transparent thin film F1 is formed on a formation region of the substrate P. That is, the first transparent thin film F1 is formed as the first layer of a film body constituting the color developing structure C (first process).

Next, liquid droplets of a second liquid material including a material (second formation material) for forming the second transparent thin film using the liquid drop ejection apparatus IJ are applied onto the first transparent thin film F1 with a predetermined thickness, and then it is dried and baked under the same conditions. As a result, the second transparent thin film F2 is formed as the second layer of a film body constituting the color developing structure C (second process). In other words, this second transparent thin film F2 that is formed on the first transparent thin film F1 is formed as a first layer of the second transparent thin film F2 in a plurality of layers of the film body constituting the color developing structure C.

The first process and the second process as described above are alternately repeated, that is the first process is performed six times and the second process is performed five times, thereby forming a color developing structure C in which the first transparent thin film F1 and the second transparent thin film F2 are formed with a predetermined thickness.

In the embodiment, the color developing structure C is formed using the thin film materials, in which the refractive index (first refractive index) of the first transparent thin film F1 is less than the refractive index (second refractive index) of the second transparent thin film F2, and the thickness of the first transparent thin film F1 is greater than the thickness of the second transparent thin film F2.

As a color developing characteristics (first color developing characteristics) of the color developing structure C having the multilayer structure, reflected light RL1 reflected by the uppermost layer transparent thin film with respect to incident light IL interferes with reflected light RL2 to RL11 that refracts and enters the transparent thin film and is reflected by the next layer transparent thin film and the layer transparent thin films below it and passes out.

On the basis of a thin film interference theory, in an interference color (reflective wavelength) and in an intensity, when refractive indexes of the first transparent thin film F1 and the second transparent thin film F2 are n1 and n2, respectively, thicknesses of the first transparent thin film F1 and the second transparent thin film F2 are t1 and t2, respectively, and refractive angles of the first transparent thin film F1 and the second transparent thin film F2 are θ1 and θ2; a reflective wavelength λ is represented by the following formula.

λ=2×(n1×t1×cos θ1+n2×t2×cos θ2) (1)

A reflectance (reflective intensity) R is represented by the following formula.

R=(n1²−n2²)/(n1²+n2²) (2)

As clearly seen from the formula (1) representing the reflectance, the difference between the refractive indexes of the first transparent thin film F1 and the second transparent thin film F2 is large. Accordingly, the reflective intensity (color developing intensity) increases as much as the difference.

When the following formula is satisfied, the color developing intensity becomes maximized.

n1×t1=n2×t2=λ/4 (3)

When the materials of the first transparent thin film F1 and the second transparent thin film F2 are selected, for example, on the basis of the reflective intensity; the refractive indexes n1 and n2 and the refractive angles θ1 and θ2 are determined. Accordingly, using the formulas (1) to (3), it is possible to set the number of layers to obtain desired color developing characteristics (λ), the thickness t1 of the first transparent thin film F1 and the thickness t2 of the second transparent thin film F2, and a desired reflectance.

### EXAMPLE

A first transparent thin film F1 and a second transparent thin film F2 were formed using a first liquid material including a siloxane polymer (refractive index 1.42) as the first transparent thin film F1 and using a second liquid material including a titanium oxide (refractive index 2.52) as the second transparent thin film F2.

For example, to produce a blue color (λ=480 nm), the first transparent thin film F1 was formed with a thickness t1 of 84.5 nm and the second transparent thin film F2 was formed with a thickness t2 of 47.6 nm, on the basis of the formula (3).

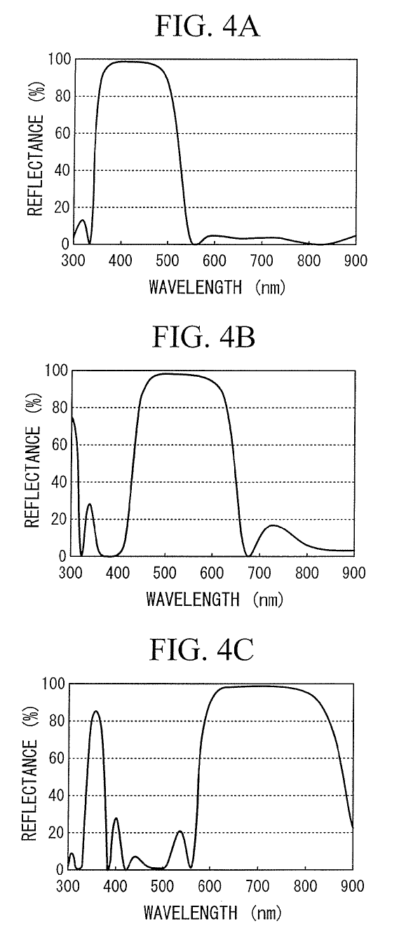

As a result, as shown in FIG. 4A, it is possible to obtain blue color developing characteristics at a reflectance that is greater than or equal to 80%.

Similarly, for example, to produce a green color (λ=520 nm), the first transparent thin film F1 was formed with a thickness t1 of 91.5 nm and the second transparent thin film F2 was formed with a thickness t2 of 52.0 nm, on the basis of the formula (3).

As a result, as shown in FIG. 4B, it is possible to obtain green color developing characteristics at a reflectance that is greater than or equal to 80%.

Similarly, for example, to produce a red color (λ=630 nm), the first transparent thin film F1 was formed with a thickness t1 of 111.0 nm and the second transparent thin film F2 was formed with a thickness t2 of 62.5 nm, on the basis of the formula (3).

As a result, as shown in FIG. 4C, it is possible to obtain red color developing characteristics at a reflectance that is greater than or equal to 80%.

In the embodiment, the first transparent thin film F1 and the second transparent thin film F2 are alternately stacked in layers by using a liquid droplet ejection method so that each of the thicknesses of the first transparent thin film F1 and the second transparent thin film F2 is defined based on the desired color developing characteristics. Therefore, it is possible to easily and efficiently manufacture the color developing structure C having the desired color developing characteristics without increasing the number of processes or without needing large-scale equipment.

In the embodiment, the transparent thin film layers are applied and dried (baked), and then the next transparent thin film layer is formed. Accordingly, it is possible to prevent a negative effect on the color developing characteristics caused by mixing the applied first liquid material and second liquid material, and it is possible to precisely manage the thicknesses of the layers.

### Second Embodiment

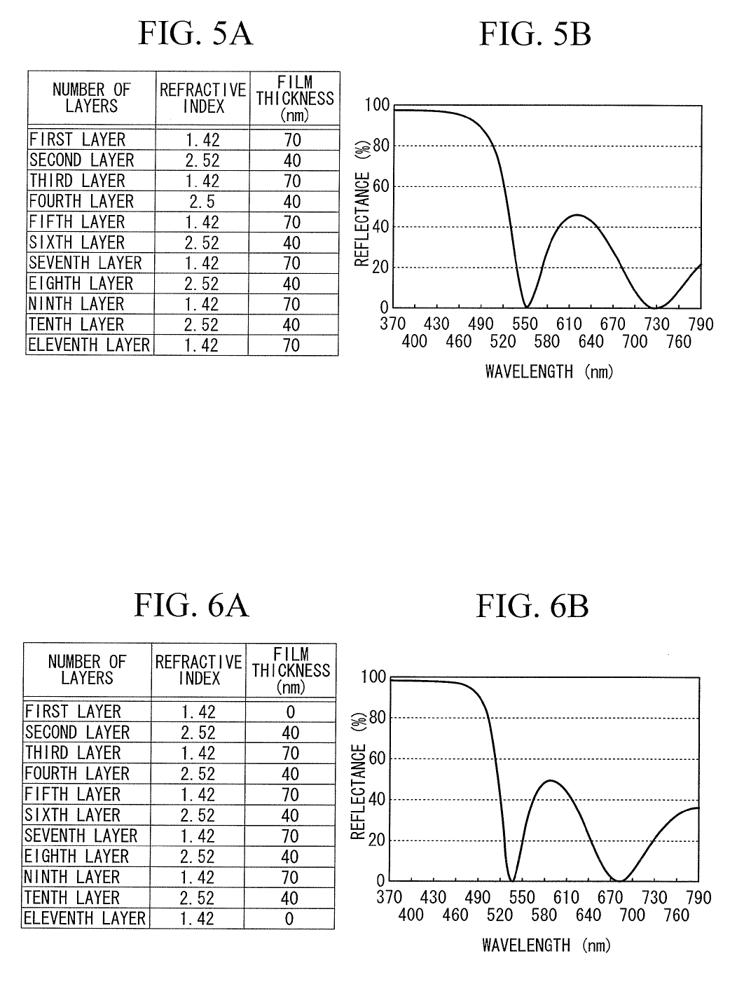

A second embodiment of a color developing structure C and a method for manufacturing the same will be described with reference to FIGS. 5A to 12B.

In the first embodiments, the first transparent thin film F1 and the second transparent thin film F2 are formed with the same thickness, respectively. However, in the second embodiment, in the above-described film body including the uppermost layer, the lowermost layer, and a plurality of intermediate layers, each of the thicknesses of the uppermost layer and the lowermost layer is different from the thickness of the one layer constituted of the intermediate layers.

As described above, FIG. 5A shows the first transparent thin film F1 formed by the siloxane polymer (refractive index 1.42) in the odd layers, and the second transparent thin film F2 formed by the titanium oxide (refractive index 2.52) in the even layers. In this case, in order to obtain a blue reflective spectrum of a wavelength of 430 to 450 nm, the thickness of the first transparent thin film F1 is 70 nm, and the thickness of the second transparent thin film F2 is 40 nm.

FIG. 5B is a diagram illustrating light emitting characteristics, specifically illustrating the relationship between a light emitting wavelength and a reflectance in the color developing structure C that is formed of the first transparent thin films F1 and the second transparent thin films F2 and has the eleven layers shown in FIG. 5A.

FIGS. 6A to 12A are diagrams illustrating that the thicknesses of the first layer that is the lowermost layer and the eleventh layer that is the uppermost layer are changed 0 times (i.e., thickness is zero), 0.5 times, 1.5 times, 2 times, 3 times, four times, and five times the thickness of the transparent thin film that has a great thickness (70 nm) in the first transparent thin film F1 and the second transparent thin film F2 that constitute one of the intermediate layers (second to tenth layers) shown in FIG. 5A.

FIGS. 5B to 12B are diagrams illustrating light emitting characteristics, specifically illustrating the relationship between a light emitting wavelength and a reflectance in the color developing structure C that is formed of the first transparent thin films F1 and the second transparent thin films F2 and has the eleven layers shown in FIGS. 5A to 12A.

As shown in the light emitting characteristics of FIGS. 5B, 6B, and 7B, when the thicknesses of the uppermost layer and the lowermost layer are less than the thickness of the layer that constitutes one of the intermediate layers and has a great thickness in the intermediate layers, a reflective peak becomes large in a wavelength region except for a predetermined region.

As shown in the light emitting characteristics of FIGS. 8B, 9B, and 12B, when the thicknesses of the uppermost layer and the lowermost layer are 1.5 times, 2 times, and 5 times the thickness of the layer that constitutes one of the intermediate layers and has a great thickness in the intermediate layers, it is possible to decrease a reflective peak in a wavelength region except for a predetermined region.

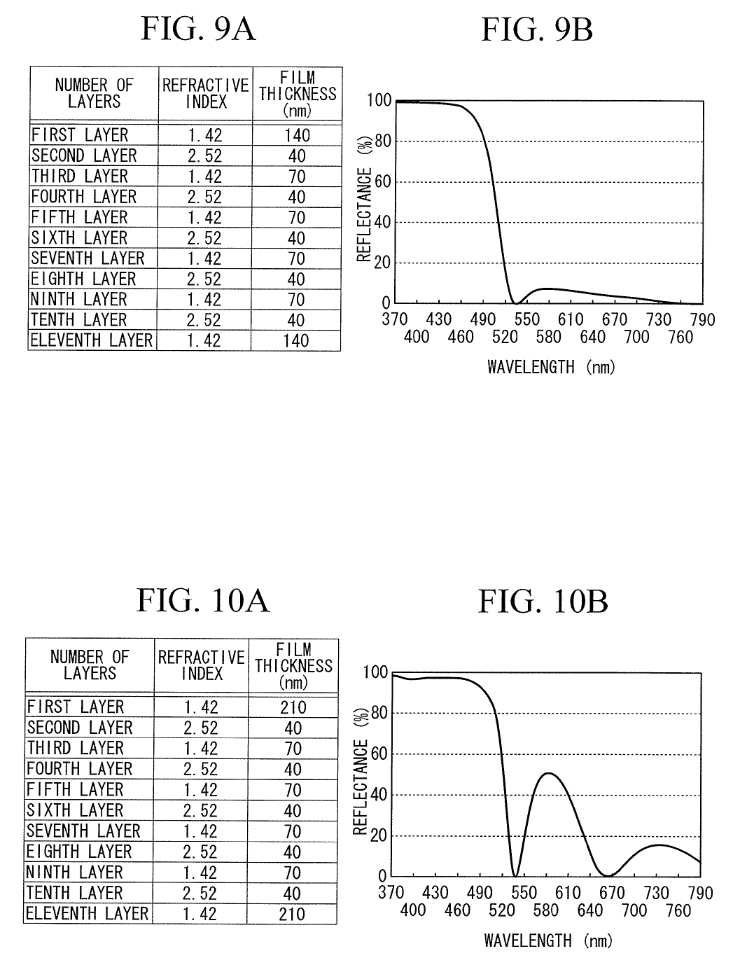

As shown in the light emitting characteristics of FIGS. 9B, 10B, and 11B, when the thicknesses of the uppermost layer and the lowermost layer are 2 times, 3 times, and 4 times the thickness of the layer that constitutes one of the intermediate layers and has a great thickness in the intermediate layers, it is possible to decrease a wavelength region of a reflective peak occurring in a region except for a predetermined region.

Accordingly, in the embodiment, in addition to the same effect as the first embodiment, it is possible to obtain more satisfactory color developing characteristics by the uppermost layer and the lowermost layer having thicknesses greater than that of the layer that constitutes one of the intermediate layers and has a great thickness in the intermediate layers.

Particularly, in the embodiment, the thicknesses of the uppermost layer and the lowermost layer are formed 2 times (twice) the thickness of the layer that constitutes one of the intermediate layers and has a great thickness in the intermediate layers. Accordingly, it is possible to decrease the reflective peak in the wavelength region except for a predetermined region, and it is possible to decrease the wavelength region of the reflective peak occurring in the region except for a predetermined region, thereby obtaining a more satisfactory color developing characteristics.

### Third Embodiment

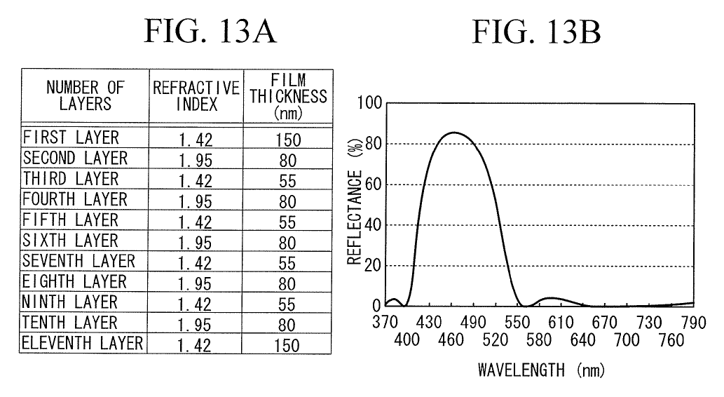

A third embodiment of a color developing structure C and a method for manufacturing the same will be described with reference to FIGS. 13A and 13B.

In the first and second embodiments, with respect to the first transparent thin film F1 and the second transparent thin film F2, the thickness of the first transparent thin film F1 having a small refractive index is greater than the thickness of the second transparent thin film F2 having a large refractive index. However, the third embodiment has a configuration opposite to that.

FIG. 13A shows a diagram illustrating thicknesses of the first transparent thin film F1 formed by a siloxane polymer (refractive index 1.42) in the odd layers and the second transparent thin film F2 formed by a zinc oxide (refractive index 1.95) in the even layers as described above. FIG. 13B is a diagram illustrating light emitting characteristics, specifically illustrating the relationship between a light emitting wavelength and a reflectance in the color developing structure C having the eleven layers shown in FIG. 13A.

As shown in FIG. 13A, in the embodiment, except for the thicknesses of the uppermost layer and the lowermost layer, the thickness of the first transparent thin film F1 having a small refractive index is less than the thickness of the second transparent thin film F2 having a large refractive index.

Similarly with the second embodiment, the thicknesses of the uppermost layer and the lowermost layer are greater than the thickness of the layer that constitutes one of the intermediate layers and has a great thickness in the intermediate layers.

As shown in FIG. 13B, also in the embodiment, it is possible to decrease the reflective peak in the wavelength region except for a predetermined region, and it is possible to decrease the wavelength region of the reflective peak occurring in the region except for a predetermined region, thereby obtaining a more satisfactory color developing characteristics.

As the color developing structure C described in the first to third embodiments, the invention can be widely applied to, for example, decorative members such as a clock character sheet, a bracelet, a brooch, and a mobile phone case (decorative member, exterior member). In addition, it is possible to efficiently (easily) form a decorative member (decorative member, exterior member) by using the color developing structure and the method for manufacturing the same. Accordingly, it is possible to obtain a decorative member (decorative member, exterior member) excellent in productivity with reduced cost.

The embodiments according to the invention have been described with reference to the accompanying drawings, but the invention is not limited to the related examples.

In the above-described examples, all shapes and combinations of the constituent elements are just examples, and may be variously modified within the scope of the concept of the invention on the basis of the design requirements or the like.

For example, in the embodiment, the first transparent thin film F1 is formed in the odd layer and the second transparent thin film F2 is formed in the even layer, but the invention is not limited thereto and it may be opposite thereto.

The number of transparent thin films described in the embodiment is an example. If desired refractive characteristics can be obtained, the number may be greater than or less than eleven layers, that is, the number may be any number.

As the thickness of the transparent thin film in the embodiment, at least one of the first transparent thin film F1 and the second transparent thin film F2 may be formed to have a thickness as big as the particle diameter of the material for forming the first transparent thin film or the material for forming the second transparent thin film.

In this case, in order not to pile particles included in the applied liquid material upon the layer, it is preferable to employ a method in which the liquid material contains a dispersion catalyst.

When the transparent thin film having a thickness greater than the particle diameter is formed, it is possible to precisely form a film having a regular thickness with uniformity by making the thickness of the transparent thin film be integer times the particle diameter and by repeating the process for forming the film having the thickness as big as the particle diameter.

In the above-described embodiments, as a method for applying liquid materials for forming the first transparent thin film F1 and the second transparent thin film F2, a liquid droplet ejection method is used. The embodiment of the invention is not limited to the liquid droplet ejection method. Other application methods employing a liquid phase method, such as a spin coating or printing method, may be used.

While preferred embodiments of the invention have been described and illustrated above, these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A method for manufacturing a color developing structure, comprising:
forming a first transparent thin film having a first refractive index with a first liquid material so that the first transparent thin film has a thickness determined based on predetermined color developing characteristics;
forming a second transparent thin film having a second refractive index with a second liquid material so that the second transparent thin film has a thickness determined based on the predetermined color developing characteristics; and
stacking the first transparent thin films and the second transparent thin films in layers by alternately repeating the forming of the first transparent thin film and the forming of the second transparent thin film multiple times so that the color developing structure having the predetermined color developing characteristics is obtained.

2. The method according to claim 1, wherein
at least one of the first transparent thin film and the second transparent thin film is formed by a liquid droplet ejection method.

3. The method according to claim 1, wherein
each of the forming of the first transparent thin film and the forming of the second transparent thin film includes:
applying a liquid material; and
baking or drying the liquid material that has been applied.

4. The method according to claim 1, wherein
the first refractive index is less than the second refractive index, and the first transparent thin film is formed so that the thickness of the first transparent thin film is greater than the thickness of the second transparent thin film.

5. The method according to claim 1, wherein
the color developing structure that is constituted by a plurality of the first transparent thin films and a plurality of the second transparent thin films includes a lowermost layer, an uppermost layer, and a plurality of intermediate layers, and wherein
the first transparent thin films and the second transparent thin films are formed so that the thicknesses of transparent thin films that are positioned at the lowermost layer and the uppermost layer are greater than the thickness of a transparent thin film that is positioned at one of the intermediate layers.

6. The method according to claim 5, wherein
the first transparent thin films and the second transparent thin films are formed so that the thicknesses of the transparent thin films that are positioned at the lowermost layer and the uppermost layer are twice the thickness of the transparent thin film that is positioned at one of the intermediate layers.

7. The method according to claim 1, wherein
the forming of the first transparent thin film and the second transparent thin film includes at least one of the forming the first transparent thin film that has the thickness determined based on a particle diameter of a first formation material used for forming the first transparent thin film, and the forming the second transparent thin film that has the thickness determined based on a particle diameter of a second formation material used for forming the second transparent thin film.

8. A color developing structure comprising:
a first transparent thin film that is formed with a first formation material, has a thickness determined based on predetermined color developing characteristics, and has a first refractive index; and
a second transparent thin film that is formed with a second formation material, has a thickness determined based on the predetermined color developing characteristics, and has a second refractive index, wherein
the first transparent thin films and the second transparent thin films are alternately stacked in layers.

9. The color developing structure according to claim 8, wherein
the first refractive index is less than the second refractive index, and the first transparent thin film is formed so that the thickness of the first transparent thin film is greater than the thickness of the second transparent thin film.

10. The color developing structure according to claim 8, wherein
the color developing structure that is constituted by a plurality of the first transparent thin films and a plurality of the second transparent thin films includes a lowermost layer, an uppermost layer, and a plurality of intermediate layers, and wherein
the first transparent thin films and the second transparent thin films are formed so that the thicknesses of transparent thin films that are positioned at the lowermost layer and the uppermost layer are greater than the thickness of a transparent thin film that is positioned at one of the intermediate layers.

11. The color developing structure according to claim 10, wherein
the first transparent thin films and the second transparent thin films are formed so that the thicknesses of the transparent thin films that are positioned at the lowermost layer and the uppermost layer are twice the thickness of the transparent thin film that is positioned at one of the intermediate layers.

12. The color developing structure according to claim 12, wherein
the thickness of the first transparent thin film is defined based on a particle diameter of the first formation material.

13. The color developing structure according to claim 12, wherein
the thickness of the second transparent thin film is defined based on a particle diameter of the second formation material.
